(19) United States
(12) Patent Application Publication
(10) Pub. No.: US 2013/0097714 A1
(43) Pub. Date: Apr. 18, 2013

(54) APPARATUS AND METHOD FOR PROTECTING PRIVATE INFORMATION

(71) Applicant: Samsung Electronics Co., Ltd., Gyeonggi-do (KR)

(72) Inventor: Yong-Ju YU, Seoul (KR)

(73) Assignee: Samsung Electronics Co., Ltd., Gyeonggi-do (KR)

(21) Appl. No.: 13/651,800

(22) Filed: Oct. 15, 2012

(30) Foreign Application Priority Data
Oct. 14, 2011 (KR) 10-2011-0105390

(51) Int. Cl. G06F 21/24

(52) U.S. Cl. 726/26

(57) ABSTRACT

An apparatus and method for protecting private information displayed in protective content while displaying content on an external device, the apparatus including an external device for transmitting display information displayed content to a wireless terminal and temporarily freezing a screen of the external device, and the wireless terminal for displaying the same displayed content based on the display information of the content received from the external device, and transmitting processing-completed data and display information of subsequent content to the external device when protective content processing is completed.

### PRIORITY

This application claims priority under 35 U.S.C. §119(a) to a Korean Patent Application filed in the Korean Intellectual Property Office on Oct. 14, 2011 and assigned Serial No. 10-2011-0105390, the contents of which are incorporated herein by reference.

### BACKGROUND OF THE INVENTION

1. Field of the Invention

The present invention relates generally to an apparatus and method for protecting private information, and more particularly, to an apparatus and method for protecting private information displayed in protective content (or content to be protected) while displaying the content on an external device.

2. Description of the Related Art

An N-screen service has been introduced to allow a user to watch the same content on various display units such as a wireless terminal, a Television (TV), and a Personal Computer (PC).

While enjoying web content on a wireless terminal, a user may access the same web content even on a TV using the N-screen service.

However, the user's private information to be included in the web content, such as Identification (ID), password and weight, is displayed while the user enters his or her private information to enjoy the web content on the TV, which is a security compromise to the user. For example, the user's private information may be unintentionally exposed to others.

### SUMMARY OF THE INVENTION

An aspect of the present invention is to provide an apparatus and method for protecting private information displayed in protective content while displaying the content on an external device.

Another aspect of the present invention is to provide an apparatus and method for protecting private information displayed in protective content while sharing and displaying the content using an N-screen service.

According to the present invention, there is provided an apparatus for protecting private information, including an external device for transmitting, when protective content is displayed while content is being displayed, display information of the content being displayed to a wireless terminal and temporarily freezing a screen of the external device, and the wireless terminal for displaying the same content as displayed on the external device based on the display information of the content received from the external device, and for transmitting, when processing of the protective content in the displayed content is completed, processing-completed data and display information of subsequent content to the external device.

According to the present invention, there is provided a method of protecting private information, including transmitting, by an external device, when protective content is displayed while content is being displayed, display information of the content being displayed to a wireless terminal and temporarily freezing a screen of the external device, displaying, by the wireless terminal, the same content as displayed in the external device based on the display information of the content received from the external device, and transmitting, by the wireless terminal, when processing of the protective content in the displayed content is completed, processing-completed data and display information of subsequent content to the external device.

### BRIEF DESCRIPTION OF THE DRAWINGS

The above and other objects, features and advantages of the present invention will become more apparent from the following detailed description when taken in conjunction with the accompanying drawing in which:

FIG. 1 illustrates a construction of protecting private information according to an embodiment of the present invention;

FIG. 2 illustrates a process of protecting private information in content according to an embodiment of the present invention; and

FIG. 3 illustrates a process of protecting private information in content according to another embodiment of the present invention.

### DETAILED DESCRIPTION OF EMBODIMENTS OF THE INVENTION

Embodiments of the present invention will be described herein below with reference to the accompanying drawings. Like reference numbers are used to refer to like elements through at the drawings. In addition, descriptions of well-known functions and constructions are omitted for the sake of clarity and conciseness.

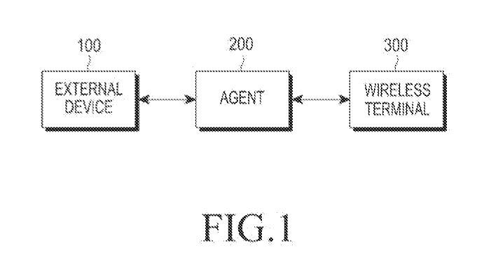

FIG. 1 illustrates a construction of protecting private information according to an embodiment of the present invention, wherein an external device 100 and a wireless terminal 300 share and display a piece of content using an N-screen service. This embodiment is described based on the assumption that session information of a Uniform Resource Locator (URL) of the piece of content is shared between the external device and the wireless terminal by performing security authentication based on an Identification (ID: OAuth) registered in the external device and the wireless terminal.

Referring to FIG. 1, an apparatus for protecting private information in content includes the external device 100, an agent 200, and the wireless terminal 300. The agent 200 is responsible for transmitting and receiving information required to protect private information between the external device 100 and the wireless terminal 300, and may be included in each of the external device 100 and the wireless terminal 300 or operate as a separate server. In this embodiment, the agent 200 is described as a separate server.

The external device 100 displays content by accessing an associated URL via the Internet in a state logged in with the same username as in the wireless terminal 300. When protective content is displayed in the content being displayed, the external device 100 transmits display information of the content being displayed to the agent 200, and temporarily freezes an entire screen area or only a portion of the entire screen area in which the protective content is displayed.

The external device 100 may use a DIVision Marker (DIV) (i.e. frame) extraction scheme to extract the protective content by using screen division information of the non-protective content being displayed. Herein, protective content includes private information included in the web content, such as Identification (ID), password and weight, and content refers to all content that is initially displayed, including the protective content. The DIV extraction scheme is for extracting content area to be protected in which private information is displayed, which is divided per DIV, by using a TAG function of Hypertext Markup Language 5 (HTML5), and in this case, the content area to be protected should be previously defined. For example, if a login content area is previously defined as the content area to be protected, when login content is displayed while content is being displayed, the login content may be extracted as protective content.

The external device 100 transmits a content URL in which the protective content is being displayed and session information to the agent 200 as the display information of the content. The display information may include area information (e.g., “DIV name: login”) of the protective content that is extracted based on the screen division information. Otherwise, the external device 100 transmits only URL information of the protective content to the agent 200 as the display information of the content.

The external device 100 may transmit the display information of the content being displayed to the agent 200 according to a user's selection while the content is being displayed.

When processing-completed data of the protective content and display information of subsequent content from the wireless terminal 300 are received when the screen is in a temporarily frozen state, the external device 100 releases the temporarily frozen screen and displays the subsequent content by accessing an associated URL based on the display information of the subsequent content and then perform a subsequent process.

In this embodiment, the external device 100 may be a smart TV.

If the display information of the content is received from the external device 100, the agent 200 may transmit the display information of the content to the wireless terminal 300 logged in with the same username as in the external device 100.

If the processing-completed data of the protective content and the display information of the subsequent content are received from the wireless terminal 300, the agent 200 transmits the processing-completed data of the protective content and the display information of the subsequent content to the external device 100.

If the display information of the content is received from the agent 200 while the agent 200 is logged in with the same username as in the external device 100, the wireless terminal 300 displays the same content as displayed on the external device 100 based on the display information of the content.

When the content URL and the session information are included in the received display information of the content, the wireless terminal 300 displays the same content that is displayed on the external device 100 by accessing the content URL based on the session information or by extracting and displaying only an area of the protective content from the same content based on the screen division information of the content.

When the content URL, the session information, and area information of the protective content are included in the received display information of the content, the wireless terminal 300 displays the same content that is displayed on the external device 100 by accessing the content URL based on the session information or by extracting and displaying only the area of the protective content from the same content based on information regarding the area of the protective content.

When only the URL information of the protective content is included in the received display information of the content, the wireless terminal 300 displays only the protective content by accessing a URL of the protective content.

When processing of the protective content is completed, the wireless terminal 300 in step 110 transmits processing-completed data of the protective content and a subsequent content URL as display information of subsequent content to the agent 200, according to a user's selection.

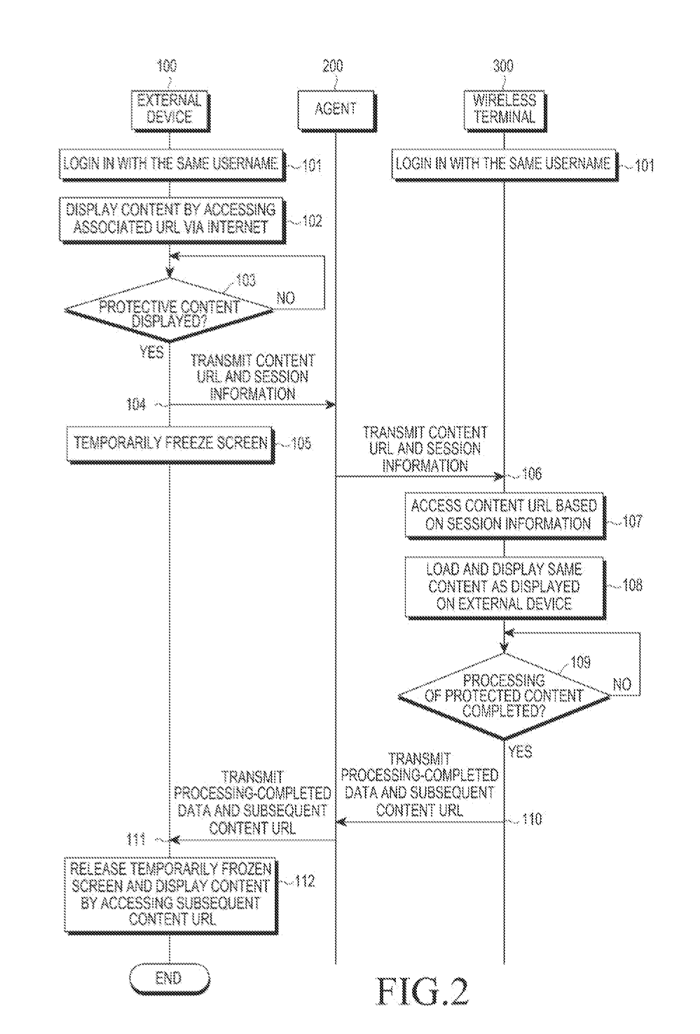

FIG. 2 illustrates a process of protecting private information in content according to an embodiment of the present invention, with reference to FIG. 1.

When the external device 100 and the wireless terminal 300 are logged in with the same username in step 101, the external device 100 displays content by accessing an associated URL via the Internet in step 102. If protective content is included in the content displayed in step 103, a controller (which is not illustrated) of the external device 100 detects the protective content based on screen division information of the content and transmits the content URL and session information to the agent 200 as display information of the content being displayed at the moment in step 104. In step 105, the external device 100 temporarily freezes an entire screen area of the external device 100 or a portion of the entire screen area in which the protective content is displayed.

In step 106, the agent 200 transmits the content URL and the session information received from the external device 100 to the wireless terminal 300 logged in with the same username as in the external device 100.

Upon receiving the content URL and the session information from the agent 200, a controller of the wireless terminal 300 accesses the content URL based on the session information in step 107 and loads and displays the same content as displayed on the external device 100 in step 108.

When processing of the protective content is completed by a user in step 109, the user of the wireless terminal 300 controls the wireless terminal 300 to transmit processing-completed data of the protective content and a subsequent content URL to the agent 200 in step 110.

Upon receiving the processing-completed data of the protective content and the subsequent content URL from the wireless terminal 300, the agent 200 transmits the processing-completed data of the protective content and the subsequent content URL received from the wireless terminal 300 to the external device 100 in step 111.

Upon receiving the processing-completed data of the protective content and the subsequent content URL from the agent 200, the external device 100 releases the temporarily frozen screen and displays associated content by accessing the received subsequent content URL in step 112, after which the process of FIG. 1 ends.

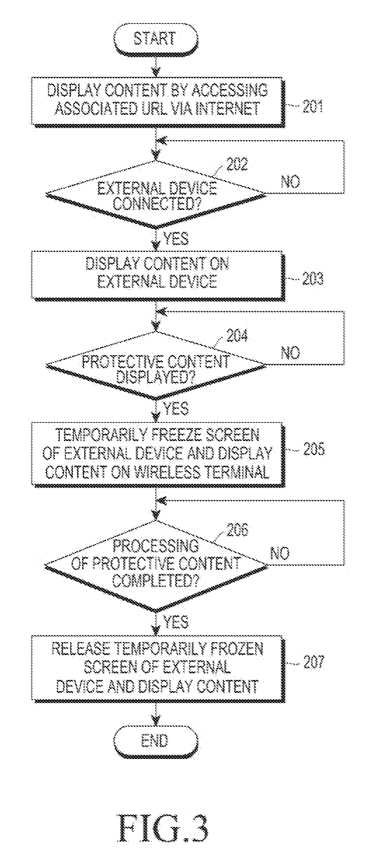

FIG. 3 illustrates a process of protecting private information in content according to another embodiment of the present invention. In this embodiment, a process of displaying content of a wireless terminal on an external device physically connected to the wireless terminal under control of the wireless terminal is described.

Referring to FIG. 3, while the wireless terminal is displaying content by accessing an associated URL via the Internet in step 201, if the external device is connected to the wireless terminal, a controller of the wireless terminal detects this connection in step 202 and automatically or manually displays the content being displayed on the wireless terminal on the external device in step 203.

While the external device is displaying content under control of the wireless terminal, if protective content is displayed in the content being displayed, the controller of the wireless terminal detects the protective content based on screen division information automatically or according to a user's selection in step 204 and displays the content being displayed on the external device on the wireless terminal in step 205. In step 205, the controller of the wireless terminal controls the external device to temporarily freeze an entire screen area of the external device or a portion of the entire screen area in which the protective content is displayed.

While the wireless terminal is displaying the content including the protective content or only the protective content, when processing of the protective content is completed by the user, the controller of the wireless terminal detects this in step 206 and controls the external device in step 207 to release the temporarily frozen screen of the external device and display content that is received after the processing of the protective content is completed.

The wireless terminal may proceed to step 207 by detecting that the processing of the protective content has been completed automatically or manually according to a user's selection output to the external device.

As is apparent from the foregoing description, the disclosed apparatus and method for protecting private information displayed on protective content while an external device is displaying content allows the private information to be protected.

While the invention has been shown and described with reference to certain embodiments, such as a wireless terminal, thereof, it will be understood by those skilled in the art that various changes in form and details may be made therein without departing from the spirit and scope of the invention as defined by the appended claims and their equivalents.

What is claimed is:

1. An apparatus for protecting private information, comprising:
an external device for transmitting, when protective content is displayed on the external device while content is being displayed on the external device, display information of the content being displayed to a wireless terminal and temporarily freezing a screen of the external device; and
the wireless terminal for displaying identical content that is being displayed on the external device based on the display information of the content received from the external device, and for transmitting, when processing of the protective content in the displayed content is completed, processing-completed data and displaying information of subsequent content to the external device.

2. The apparatus of claim 1, wherein the external device and the wireless terminal are logged in with an identical username.

3. The apparatus of claim 1, wherein, when protective content is displayed at an instant when the external device is displaying the content by accessing an associated Uniform Resource Locator (URL) via the Internet, the external device transmits a content URL being displayed at the instant and session information to the wireless terminal, and
when processing-completed data of the protective content and a subsequent content URL are received from the wireless terminal, the external device displays associated content by accessing the subsequent content URL.

4. The apparatus of claim 1, wherein the external device temporarily freezes an entire screen area or a portion of the entire screen area in which the protected screen is displayed after transmitting an Internet address of the content being displayed to the wireless terminal.

5. The apparatus of claim 1, wherein, when a content URL and session information are received from the external device, the wireless terminal displays the identical content displayed on the external device or protective content in the identical displayed content by accessing the received content URL based on the received session information, and when processing of the protective content is completed, the wireless terminal transmits processing-completed data and a subsequent content URL to the external device.

6. The apparatus of claim 1, wherein the external device and the wireless terminal extract an area of the protective content based on screen division information of the content.

7. The apparatus of claim 1, wherein the external device transmits the display information of the content, the display information including area information of the protective content.

8. The apparatus of claim 1, further comprising an agent for transmitting a content URL and session information transmitted from the external device to the wireless terminal and transmitting processing-completed data of protective content and a subsequent content URL transmitted from the wireless terminal to the external device.

9. The apparatus of claim 1, wherein, when the wireless terminal is connected to the external device, the wireless terminal outputs content being displayed on the wireless terminal to the external device to display the content on the external device, when protective content is displayed while content is being displayed on the external device, temporarily freezes a screen of the external device and displays the content being displayed on the external device on the wireless terminal, and when processing of the protective content is completed by the wireless terminal, displays content on the external device.

10. The apparatus of claim 9, wherein the wireless terminal extracts an area of the protective content based on screen division information of the content.

11. A method of protecting private information, comprising:
transmitting, by an external device, when protective content is displayed on the external device while content is being displayed on the external device, display information of the content being displayed to a wireless terminal and temporarily freezing a screen of the external device;
displaying, by the wireless terminal, identical content that is being displayed on the external device based on the display information of the content received from the external device; and
transmitting, by the wireless terminal, when processing of the protective content in the displayed content is completed, processing-completed data and display information of subsequent content to the external device.

12. The method of claim 11, wherein the external device and the wireless terminal are logged in with an identical username.

13. The method of claim 11, wherein the temporarily freezing comprises:
displaying, by the external device, content by accessing an associated Uniform Resource Locator (URL) via the Internet;
transmitting, at an instant when protective content is displayed while content is being displayed, a content URL being displayed at the instant and session information to the wireless terminal; and
temporarily freezing, after transmitting the content URL and the session information to the wireless terminal, an entire screen area or a portion of the entire screen area in which the protected screen is displayed.

14. The method of claim 11, wherein displaying the identical content being displayed comprises displaying, by the wireless terminal, when a content URL and session information are received from the external device, the identical content displayed on the external device or protective content in the identical content by accessing the received content URL based on the received session information.

15. The method of claim 11, further comprising displaying, by the external device, when processing-completed data of protective content and a subsequent content URL are received from the wireless terminal, associated content by accessing the subsequent content URL.

16. The method of claim 11, wherein the external device and the wireless terminal extract an area of the protective content based on screen division information of the content.

17. The method of claim 11, wherein, when the external device transmits the display information of the content, the display information includes area information of the protective content.

18. The method of claim 11, further comprising:
outputting, by the wireless terminal, when the wireless terminal is connected to the external device, content being displayed on the wireless terminal to the external device to display the content on the external device;
temporarily freezing, when protective content is displayed while content is being displayed on the external device, a screen of the external device and displaying the content being displayed on the external device on the wireless terminal; and
outputting, when processing of the protective content is completed by the wireless terminal, content to the external device and displaying the content on the external device.

19. The method of claim 18, wherein the wireless terminal extracts an area of the protective content based on screen division information of the content.
